(19) United States
(12) Patent Application Publication
(10) Pub. No.: US 2023/0052961 A1
(43) Pub. Date: Feb. 16, 2023

(54) HIGH FREQUENCY PROCESSING DEVICE

(71) Applicant: PANASONIC INTELLECTUAL PROPERTY MANAGEMENT CO., LTD., Osaka (JP)

(72) Inventors: YOSHIHARU OOMORI, Shiga (JP); DAISUKE HOSOKAWA, Shiga (JP); HIDEKI NAKAMURA, Kyoto (JP); KAZUKI MAEDA, Shiga (JP); TAKASHI UNO, Shiga (JP)

(21) Appl. No.: 17/758,576

(22) PCT Filed: Jan. 26, 2021
(86) PCT No.: PCT/JP2021/002531

§ 371 Date: Jul. 10, 2022

(30) Foreign Application Priority Data
Feb. 21, 2020 (JP) 2020-027700

(51) Int. Cl. H05B 6/68; H05B 6/70; H05B 6/64

(52) U.S. Cl. CPC H05B 6/686; H05B 6/705; H05B 6/6447

(57) ABSTRACT

The high-frequency treatment device according to one embodiment of the present disclosure includes: a heating chamber that accommodates a heating target; an oscillator; at least one feeder; a detector; and a controller. The oscillator generates high-frequency power having an arbitrary frequency in a predetermined frequency band. At least one feeder supplies incident microwave power based on the high-frequency power to the heating chamber. The detector detects the incident microwave power and reflected microwave power returning from the heating chamber to at least one feeder. The controller causes the oscillator to execute a frequency sweep and measures a reflection characteristic based on the incident microwave power and the reflected microwave power for each heating condition including a frequency. The controller determines, based on a reflection variation range indicating a change in the reflection characteristic for each heating condition, a heating condition to be used next. According to the present aspect, various heating targets can be optimally heated.

### BACKGROUND

### 1. Technical Field

The present disclosure relates to high-frequency treatment devices.

### 2. Description of the Related Art

For example, Patent Literature (PTL) 1 discloses a modal condition that refers to the relationship between the wavelength of an electromagnetic wave and the dimension of a casing to cause resonance in a heating space.

According to PTL 1, when the modal condition is met, selecting a combination of a field pattern and electric power to be supplied enables heating in intended heating distribution. A combination of the field pattern and the electric power to be supplied is determined using parameters concerning the frequency, the phase, and other modulation space elements (MSEs).

### CITATION LIST

### Patent Literature

PTL 1: Unexamined Japanese Patent Publication No. 2016-129141

### SUMMARY

However, the distribution of electric power that is absorbed by a heating target changes depending on, for example, the shape of the heating target, the quantity of the heating targets, the number of processing steps, the position of the heating target, and the permittivity distribution within the heating target. Continuous heating of the heating target with high frequency power under the influence just mentioned causes a shift in electromagnetic field distribution in the internal space of the casing as compared to that in a resonating state with no load.

At the start of heating, estimating the distribution of the high frequency power during heating is difficult. By using an infrared sensor or the like, it is possible to recognize changes in temperature distribution during heating. However, it is very difficult to provide electromagnetic field distribution with which generated temperature variations can be modified.

Even when the frequency or the like is switched, without proper recognition of the distribution of electric power that is absorbed by the heating target, it is difficult to practically improve heating evenness.

The present disclosure is conceived to solve this existing problem and has an object to provide a high-frequency treatment device capable of properly heating various heating targets.

A high-frequency treatment device according to one aspect of the present disclosure includes: a heating chamber configured to accommodate a heating target; an oscillator; at least one feeder; a detector; and a controller.

The oscillator generates high-frequency power having an arbitrary frequency in a predetermined frequency band. At least one feeder supplies incident microwave power based on the high-frequency power to the heating chamber. The detector detects the incident microwave power and reflected microwave power returning from the heating chamber to at least one feeder.

The controller causes the oscillator to execute a frequency sweep and measures a reflection characteristic based on the incident microwave power and the reflected microwave power for each heating condition including a frequency. The controller determines, based on a reflection variation range indicating a change in the reflection characteristic for each heating condition, a heating condition to be used next.

According to the present aspect, various heating targets can be optimally heated.

### BRIEF DESCRIPTION OF THE DRAWINGS

FIG. 1 is a schematic configuration diagram showing a high-frequency heating device according to one example of an exemplary embodiment of the present disclosure;

FIG. 2A is a schematic configuration diagram showing an analytical model for the configuration shown in FIG. 1;

FIG. 2B is a diagram showing the distribution of physical property values within a heating target before heating in the analytical model shown in FIG. 2A;

FIG. 2C is a diagram showing the distribution of physical property values within the heating target after heating in the analytical model shown in FIG. 2A;

FIG. 3A is a diagram showing one example of frequency characteristics of reflected microwave power in one example of the exemplary embodiment;

FIG. 3B is a diagram showing another example of the frequency characteristics of the reflected microwave power in one example of the exemplary embodiment;

FIG. 4A is a contour map showing one example of the distribution of absorbed microwave power in one example of the exemplary embodiment;

FIG. 4B is a contour map showing one example of the distribution of absorbed microwave power in one example of the exemplary embodiment;

FIG. 5 is a schematic configuration diagram showing a high-frequency heating device according to another example of the exemplary embodiment of the present disclosure;

FIG. 6A is a schematic configuration diagram showing an analytical model for the configuration shown in FIG. 5;

FIG. 6B is a diagram showing the distribution of physical property values within a heating target before heating in the analytical model shown in FIG. 6A;

FIG. 6C is a diagram showing the distribution of physical property values within the heating target after heating in the analytical model shown in FIG. 6A;

FIG. 7A is a contour map showing one example of frequency characteristics and phase characteristics of reflected microwave power in another example of the exemplary embodiment;

FIG. 7B is a contour map showing one example of frequency characteristics and phase characteristics of the reflected microwave power in another example of the exemplary embodiment;

FIG. 7C is a contour map showing one example of frequency characteristics and phase characteristics of the reflected microwave power in another example of the exemplary embodiment;

FIG. 8 is a contour map showing one example of the distribution of absorbed microwave power in another example of the exemplary embodiment;

FIG. 9 is a flowchart showing the overall heating control according to the exemplary embodiment;

FIG. 10 is a flowchart showing details of detection process DT1; and

FIG. 11 is a flowchart showing details of detection process DT2.

### DETAILED DESCRIPTIONS

A high-frequency treatment device according to the first aspect of the present disclosure includes: a heating chamber configured to accommodate a heating target; an oscillator; at least one feeder; a detector; and a controller.

The oscillator generates high-frequency power having an arbitrary frequency in a predetermined frequency band. At least one feeder supplies incident microwave power based on the high-frequency power to the heating chamber. The detector detects the incident microwave power and reflected microwave power returning from the heating chamber to at least one feeder.

The controller causes the oscillator to execute a frequency sweep and measures a reflection characteristic based on the incident microwave power and the reflected microwave power for each heating condition including a frequency. The controller determines, based on a reflection variation range indicating a change in the reflection characteristic for each heating condition, a heating condition to be used next.

A high-frequency treatment device according to the second aspect of the present disclosure, which is based on the first aspect, further includes a phase adjuster. At least one feeder includes a first feeder and a second feeder.

The phase adjuster is connected to the oscillator and adjusts a phase difference between the high-frequency power to be supplied by the first feeder and the high-frequency power to be supplied by the second feeder. The controller causes the phase adjuster to execute a phase sweep and measures the reflection characteristic based on the incident microwave power and the reflected microwave power for each heating condition that further includes the phase difference.

In a high-frequency treatment device according to the third aspect of the present disclosure, which is based on the first aspect, the controller determines, as the heating condition to be used next, the heating condition in which an absolute value of the reflection variation range is less than a threshold value.

In a high-frequency treatment device according to the fourth aspect of the present disclosure, which is based on the third aspect, the threshold value is obtained by multiplying the absolute value of the reflection variation range by a predetermined coefficient.

A high-frequency treatment device according to the fifth aspect of the present disclosure, which is based on the first aspect, further includes a storage. The controller causes the storage to store the reflection characteristic each time the heating condition to be used next is determined.

In a high-frequency treatment device according to the sixth aspect of the present disclosure, which is based on the fifth aspect, each time the reflection variation range is calculated, the controller calculates a maximum of the reflection variation range, causes the storage to store the maximum, and determines, based on the maximum, the heating condition to be used next.

In a high-frequency treatment device according to the seventh aspect of the present disclosure, which is based on the fifth aspect, each time the reflection variation range is calculated, the controller calculates an accumulated value of the reflection variation range, causes the storage to store the accumulated value, and determines, based on the accumulated value, the heating condition to be used next.

In a high-frequency treatment device according to the eighth aspect of the present disclosure, which is based on the second aspect, the controller replaces, by zero, a value having a sign different from a sign of a value of the reflection variation range measured in the heating condition that is identical to a previous heating condition among values of the reflection variation range for each heating condition.

In a high-frequency treatment device according to the ninth aspect of the present disclosure, which is based on the fifth aspect, the frequency sweep is an operation to change the frequency at regular or irregular intervals over the predetermined frequency band. The phase sweep is an operation to change the phase difference at regular or irregular intervals over a predetermined angular range.

In a high-frequency treatment device according to the tenth aspect of the present disclosure, which is based on the fifth aspect, the controller causes the storage to store only the reflection characteristic that indicates an extremum of the change.

Hereinafter, an exemplary embodiment of the present disclosure will be described with reference to the drawings.

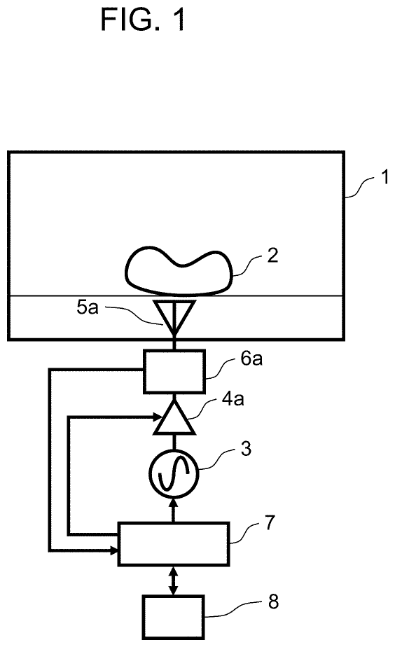

FIG. 1 is a schematic configuration diagram showing a high-frequency treatment device according to one example of an exemplary embodiment of the present disclosure. As shown in FIG. 1, the high-frequency treatment device according to the present exemplary embodiment includes heating chamber 1, oscillator 3, amplifier 4a, feeder 5a, detector 6a, controller 7, and storage 8.

Heating chamber 1 accommodates heating target 2 such as food, which is a load. Oscillator 3 includes a semiconductor element. Oscillator 3, which is capable of generating high-frequency power having a frequency in a predetermined frequency band, generates high-frequency power having a frequency designated by controller 7.

Amplifier 4a includes a semiconductor element. Amplifier 4a amplifies, according to an instruction from controller 7, the high-frequency power generated by oscillator 3, and outputs the amplified high-frequency power.

Feeder 5a, which functions as an antenna, supplies the high-frequency power amplified by amplifier 4a to heating chamber 1 as incident microwave power. In other words, feeder 5a supplies, to heating chamber 1, the incident microwave power based on the high-frequency power generated by oscillator 3. In the incident microwave power, electric power that has not been consumed by heating target 2 or the like returns from heating chamber 1 to feeder 5a as reflected microwave power.

Detector 6a includes a directional coupler, for example. Detector 6a detects the incident microwave power and the reflected microwave power and notifies controller 7 of the amounts of the detected incident microwave power and the detected reflected microwave power. In other words, detector 6a functions as both an incident-microwave-power detector and a reflected-microwave-power detector.

Detector 6a, which has a coupling of approximately −40 dB, for example, extracts approximately 1/10000 as much electric power as the incident microwave power and the reflected microwave power. The extracted incident microwave power and the extracted reflected microwave power are rectified at a detector diode (not shown in the drawings), smoothed at a capacitor (not shown in the drawings), and then converted into information corresponding to the incident microwave power and the reflected microwave power. Controller 7 receives the information.

Storage 8, which includes semiconductor memory or the like, stores data obtained from controller 7, reads the stored data, and transmits the read data to controller 7.

Controller 7 includes a microprocessor including a central processing unit (CPU). On the basis of the information from detector 6a and storage 8, controller 7 controls oscillator 3 and amplifier 4a to perform heating control of the high-frequency treatment device.

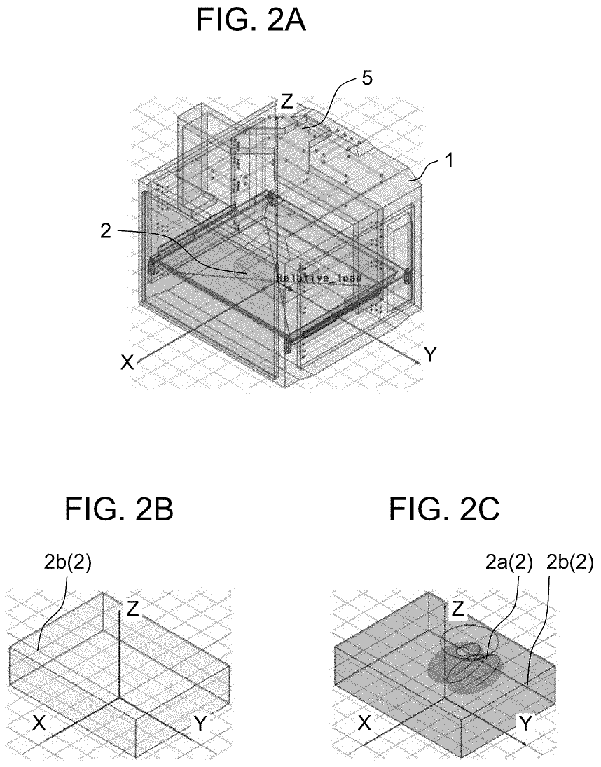

FIG. 2A is a schematic configuration diagram showing an analytical model for the configuration shown in FIG. 1. FIG. 2B and FIG. 2C three-dimensionally show the distribution of physical property values within heating target 2 in the analytical model shown in FIG. 2A.

FIG. 2B shows the distribution of physical property values within heating target 2 before heating. As shown in FIG. 2B, heating target 2 before heating is frozen meat 2b having generally uniform physical property values.

FIG. 2C shows the distribution of physical property values of heating target 2 that has been heated for a predetermined length of time with high-frequency power having a frequency of 2.45 GHz. As shown in FIG. 2C, heating target 2 after heating includes a portion having the physical property values of frozen meat 2b and a portion having the physical property values of defrosted meat 2a. This means that defrosted meat 2a and frozen meat 2b coexist in heating target 2 after heating.

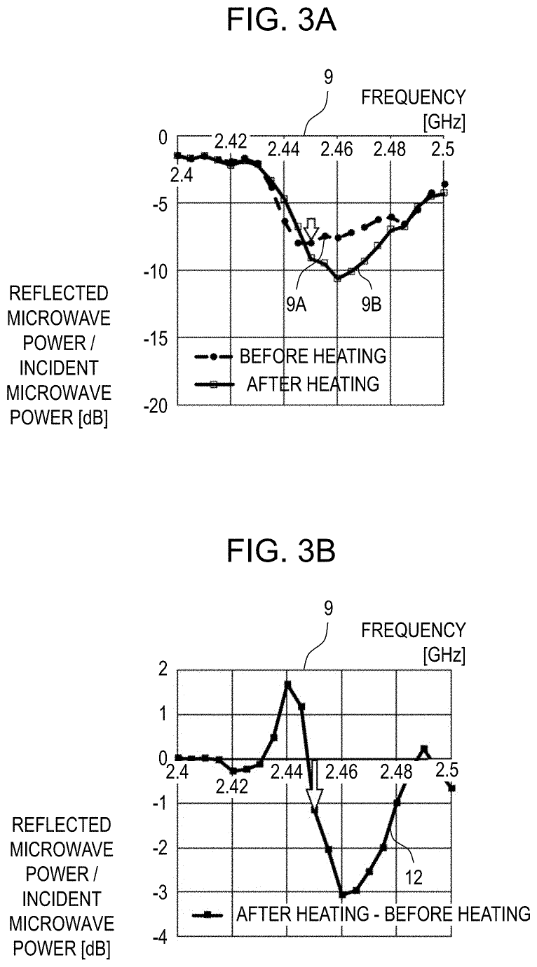

FIG. 3A and FIG. 3B are graphs each showing one example of the frequency characteristics of the reflected microwave power. In order to obtain the frequency characteristics of the reflected microwave power, oscillator 3 supplies the high-frequency power while executing a frequency sweep. The frequency sweep is an operation performed by oscillator 3 to sequentially change the frequency at predetermined frequency intervals over a predetermined frequency band.

In the present exemplary embodiment, the predetermined frequency band is 2.4 GHz to 2.5 GHz, and the predetermined frequency intervals are 0.01 GHz. The predetermined frequency intervals may be regular or irregular. Detector 6a detects the reflected microwave power originating from the high-frequency power supplied at each frequency.

The amount of high-frequency power that heating target 2 consumes changes depending on the frequency of the high-frequency power supplied thereto. Similarly, the power loss in heating chamber 1 and the resonance of heating chamber 1 also change depending on the frequency of the high-frequency power supplied thereto. Because of such frequency characteristics, the amount of loss of the high-frequency power that is consumed in heating chamber 1 changes, and the amount of the reflected microwave power also changes accordingly.

The graph showing the ratio (dB) of the amount of the reflected microwave power to the amount of the incident microwave power at each frequency (GHz) is herein referred to as reflection characteristic 9.

FIG. 3A shows reflection characteristic 9 (the dashed line) for heating target 2 before heating shown in FIG. 2B and reflection characteristic 9 (the solid line) for heating target 2 after heating shown in FIG. 2C. The curve showing the former is referred to as reflection characteristic curve 9A, and the curve showing the latter is referred to as reflection characteristic curve 9B.

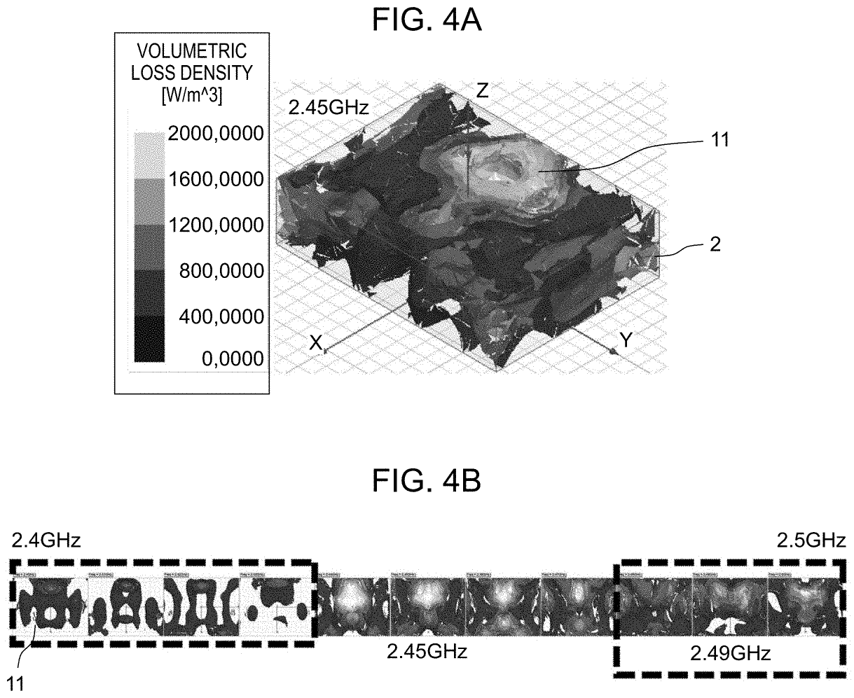

FIG. 4A and FIG. 4B each show one example of the distribution of electric power absorbed by a load. In the present exemplary embodiment, the distribution of electric power absorbed by a load is referred to as absorbed microwave power distribution 11. FIG. 4A and FIG. 4B each show, as a contour map, the absorbed microwave power distribution obtained by analyzing the state of heating target 2 that is frozen meat 2b.

FIG. 4A is a perspective view three-dimensionally showing absorbed microwave power distribution 11 within heating target 2 measured when the high-frequency power having a frequency of 2.45 GHz is supplied. As a result of defrosting for a predetermined length of time with the high-frequency power leading to absorbed microwave power distribution 11 shown in FIG. 4A, the distribution of physical property values of heating target 2 shown in FIG. 2B turns into the distribution of physical property values shown in FIG. 2C.

FIG. 4B shows absorbed microwave power distribution 11 in heating target 2 in each heating condition as viewed from above when the frequency sweep is executed and the high-frequency power is supplied. As shown in FIG. 4B, the frequencies to be used in the frequency sweep are set at intervals of 0.01 GHz between 2.4 GHz and 2.5 GHz, inclusive. In FIG. 4B, absorbed microwave power distributions 11 obtained at the frequencies are arranged in the ascending order of frequencies from the left.

As shown in FIG. 3A, there is a difference between two reflection characteristics 9 before and after heating at the frequencies between approximately 2.45 GHz and approximately 2.48 GHz. This difference is due to defrosting of a portion of heating target 2. Hereinafter, the difference between two reflection characteristics 9 before and after heating will be referred to as reflection variation range 12. FIG. 3B is a graph showing reflection variation range 12 at each frequency.

As shown in FIG. 3B, reflection variation range 12 is different at each frequency. Reflection variation range 12 differs due to defrosting of a portion of heating target 2. The fact that reflection variation range 12 is close to zero means that at the frequency, the amount of reflected microwave power is hardly influenced by defrosting of a portion of heating target 2.

For example, at a frequency of 2.49 GHz where reflection variation range 12 is close to zero in FIG. 3B, absorbed microwave power distributions 11 shown in FIG. 4B is different in different pattern from the distribution shown in FIG. 2C.

Specifically, in a frequency band where reflection variation range 12 is close to zero, a defrosted portion (defrosted meat 2a) of heating target 2 is irradiated with a small amount of high-frequency power, and therefore the impact on the amount of reflected microwave power is not significant.

Among absorbed microwave power distributions 11 shown in FIG. 4B, distributions where areas with strong electromagnetic fields are different through comparison between FIG. 4A and FIG. 2C are enclosed by the dashed lines in FIG. 4B (the range of 2.48 GHz to 2.50 GHz and the range of 2.40 GHz to 2.43 GHz). These areas substantially match frequency bands where the value of reflection variation range 12 is close to zero in FIG. 3B.

This means that by selecting a frequency to be used next from the frequency bands where the value of reflection variation range 12 is close to zero in FIG. 3B, it is possible to generate, without increasing the reflected microwave power, absorbed microwave power distribution 11 different from absorbed microwave power distribution 11 at a frequency of 2.45 GHz used for heating. In other words, the frequency of the high-frequency power is a heating condition in this case.

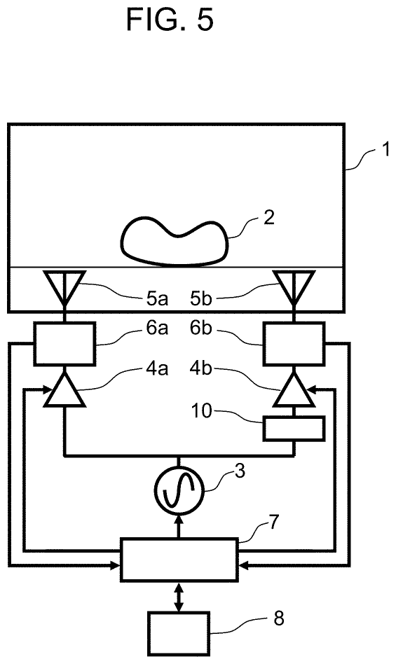

FIG. 5 is a schematic configuration diagram showing a high-frequency heating device according to another example of the present exemplary embodiment. In the high-frequency heating device according to another example, structural elements that are substantially the same as those in the high-frequency heating device according to one example described above are assigned the same reference marks and as such, description thereof will be omitted as appropriate.

As shown in FIG. 5, the high-frequency heating device according to another example further includes, in addition to the power supply path shown in FIG. 1, the second power supply path including amplifier 4b, feeder 5b, and detector 6b, which are equivalent to amplifier 4a, feeder 5a, and detector 6a, respectively. In the present aspect, the reflected microwave power returns from heating chamber 1 to feeders 5a, 5b. Feeder 5a and feeder 5b correspond to the first feeder and the second feeder, respectively.

The second power supply path includes phase adjuster 10 disposed between oscillator 3 and amplifier 4b. Phase adjuster 10 includes, for example, a variable capacitor, the capacitance of which changes according to an applied voltage. Phase adjuster 10 may be structurally integrated with oscillator 3 or may be structurally separate from oscillator 3.

Phase adjuster 10 is operable to adjust the phase of input high-frequency power in the range of zero degrees to approximately 180 degrees. Specifically, phase adjuster 10 is capable of adjusting the phase difference between the high-frequency power supplied from feeder 5a and the high-frequency power supplied from feeder 5b to fall within the range of −180 degrees to +180 degrees.

In the present aspect, the high-frequency power supplied from feeder 5a and the high-frequency power supplied from feeder 5b have a single frequency and different phases adjusted by phase adjuster 10.

By adjusting the phase difference, it is possible to change the phase of high-frequency power combined in heating chamber 1, and it is also possible to change the electromagnetic field distribution within heating chamber 1. In other words, the electromagnetic field distribution within heating chamber 1 changes due to two factors that are the frequency of one high-frequency power supplied and the other high-frequency power supplied and the phase difference between one high-frequency power supplied and the other high-frequency power supplied. In this case, the combination of the frequency and the phase difference of one high-frequency power and the other high-frequency power is a heating condition. In the present exemplary embodiment, one high-frequency power and the other high-frequency power have a single frequency.

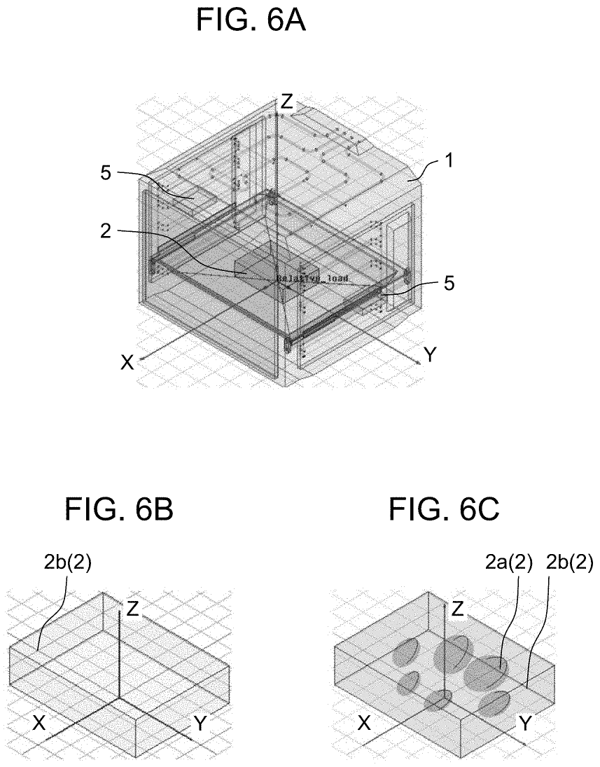

FIG. 6A is a schematic configuration diagram showing an analytical model for the configuration shown in FIG. 5. Similar to FIG. 2B and FIG. 2C, FIG. 6B and FIG. 6C three-dimensionally show the distribution of physical property values within heating target 2 in the analytical model shown in FIG. 6A.

FIG. 6B shows the distribution of physical property values within heating target 2 before heating. As shown in FIG. 6B, heating target 2 before heating is frozen meat 2b having generally uniform physical property values.

FIG. 6C shows the distribution of physical property values of heating target 2 that has been heated for a predetermined length of time with one high-frequency power and the other high-frequency power having a frequency of 2.47 GHz with a phase difference of 180 degrees. As shown in FIG. 6C, heating target 2 after heating includes a portion having the physical property values of frozen meat 2b and a portion having the physical property values of defrosted meat 2a. This means that defrosted meat 2a and frozen meat 2b coexist in heating target 2 shown in FIG. 6C.

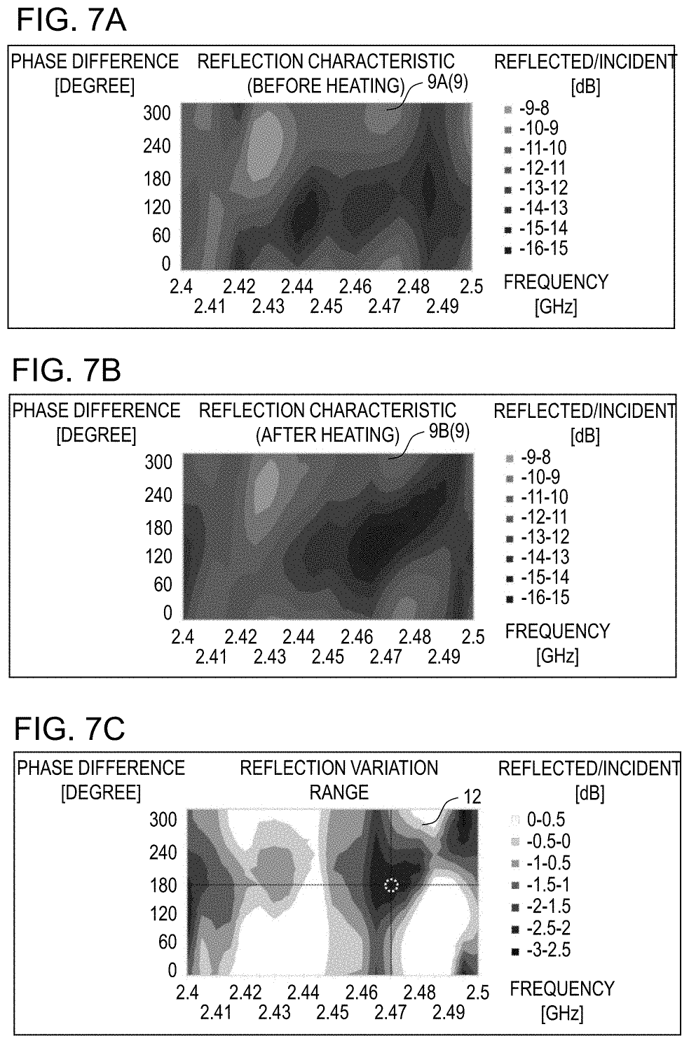

FIG. 7A to FIG. 7C are contour maps showing one example of frequency characteristics and phase characteristics of the reflected microwave power. In order to obtain the frequency characteristics and the phase characteristics of the reflected microwave power, oscillator 3 supplies the high-frequency power while executing the frequency sweep. Phase adjuster 10 executes a phase sweep on the input high-frequency power and outputs the high-frequency power the phase of which has been changed.

The phase sweep is an operation performed by phase adjuster 10 to sequentially change the phase difference between one high-frequency power and the other high-frequency power at predetermined angular intervals over a predetermined angular range. In the present exemplary embodiment, the predetermined angular range is between zero degrees and 300 degrees, and the predetermined angular intervals are 60 degrees. The predetermined angular intervals may be regular or irregular. Detectors 6a, 6b detect the reflected microwave power for each combination of the frequency and the phase difference.

In FIG. 7A to FIG. 7C, the horizontal axis represents the frequency (GHz), and the vertical axis represents the phase difference (degrees). FIG. 7A to FIG. 7C show the ratio (dB) of the amount of the reflected microwave power to the amount of the incident microwave power for each combination of the frequency and the phase difference. The brightness of a region in FIG. 7A to FIG. 7C means that the use of a heating condition corresponding to a brighter region can cause an increase in the aforementioned ratio.

As in FIG. 3A and FIG. 3B, the amount of loss of the high-frequency power that is consumed in heating chamber 1 changes according to changes in consumption, loss, etc., of the high-frequency power dependent on the frequency. Therefore, the amount of the reflected microwave power changes in conjunction.

Furthermore, the electromagnetic field distribution within heating chamber 1 changes according to the phase difference in the high-frequency power, and the amount of loss of the high-frequency power that is consumed in heating chamber 1 such as the electric power that is absorbed by a load also changes. Therefore, the amount of the reflected microwave power changes in conjunction. The contour maps shown in FIG. 7A to FIG. 7C are herein referred to as reflection characteristics 9.

FIG. 7A shows reflection characteristic 9 for heating target 2 before heating shown in FIG. 6B. FIG. 7B shows reflection characteristic 9 for heating target 2 after heating shown in FIG. 6C. FIG. 7C shows the difference between two reflection characteristics 9 before and after heating. As in FIG. 3B, this difference is referred to as reflection variation range 12.

FIG. 7A and FIG. 7B show reflection characteristics 9 obtained when the phase difference is added to the heating condition (frequency) applied to the high-frequency treatment device shown in FIG. 1. FIG. 7C shows reflection variation range 12 calculated by subtracting the value (dB) of reflection characteristic curve 9A from the value (dB) of reflection characteristic curve 9B for each combination of the frequency and the phase difference.

For example, in FIG. 7C, reflection variation range 12 in the heating condition in which the frequency is 2.47 GHz and the phase difference is 180 degrees is 2.4 dB.

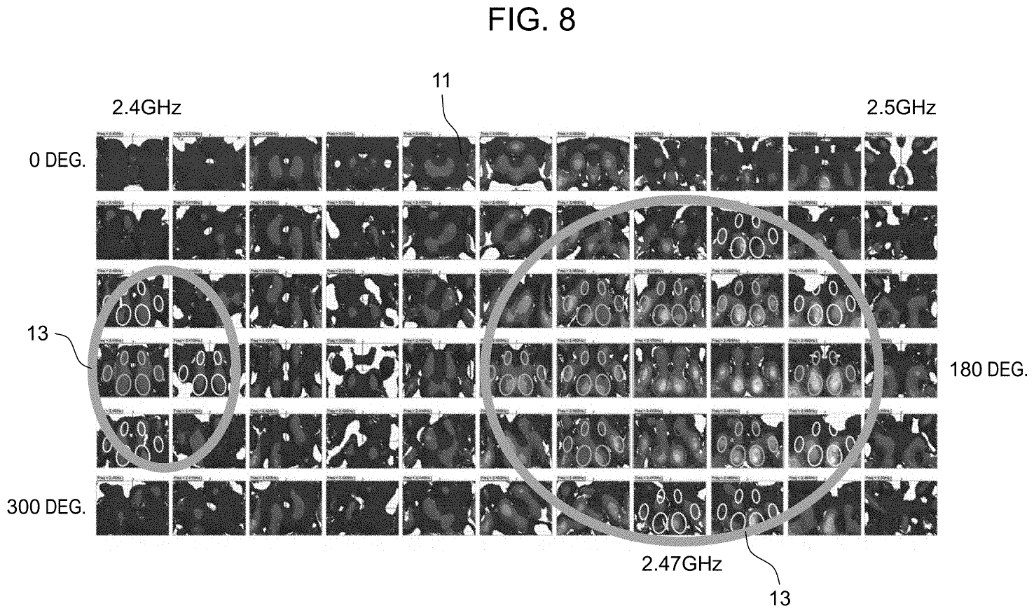

FIG. 8 shows absorbed microwave power distribution 11 in heating target 2 in each heating condition as viewed from below when the frequency sweep and the phase sweep are executed and one high-frequency power and the other high-frequency power are supplied. FIG. 8 shows, as a contour map, absorbed microwave power distribution 11 obtained by analyzing the state of heating target 2 that is frozen meat 2b shown in FIG. 6B. In FIG. 8, absorbed microwave power distributions 11 obtained in the respective heating conditions are arranged in a matrix with the frequency on the horizontal axis and the phase difference on the vertical axis.

As shown in FIG. 8, the single frequency of one high-frequency power and the other high-frequency power is set at intervals of 0.01 GHz between 2.4 GHz and 2.5 GHz, inclusive. The phase difference between one high-frequency power and the other high-frequency power is set at intervals of 60 degrees between 0 degrees and 300 degrees, inclusive.

As shown in FIG. 8, as a result of defrosting for a predetermined length of time with one high-frequency power and the other high-frequency power having a frequency of 2.47 GHz with a phase difference of 180 degrees, the distribution of physical property values of heating target 2 shown in FIG. 6B turns into the distribution of physical property values shown in FIG. 6C.

A heating condition in which among absorbed microwave power distributions 11 shown in FIG. 8, absorbed microwave power distribution 11 similar to that generated in the heating condition in which the frequency is 2.47 GHz and the phase difference is 180 degrees is generated is referred to as similar heating condition 13. Similar heating condition 13 substantially matches a combination of the frequency and the phase difference with which reflection characteristic 9 significantly changes as reflection variation range 12 shown in FIG. 7C.

Therefore, it is sufficient that the frequency and the phase difference to be used next be selected from among frequencies and phase differences with which the value of reflection variation range 12 shown in FIG. 7C is close to zero, as in the above-described one example of the present exemplary embodiment. Thus, absorbed microwave power distribution 11 different from absorbed microwave power distribution 11 used for heating at a frequency of 2.47 GHz with a phase difference of 180 degrees can be generated without an increase in the reflected microwave power.

In another example of the present exemplary embodiment, the frequency and the phase difference are used as the heating condition. However, even in the case where the heating condition further includes other variation factors such as selection of a feeder, absorbed microwave power distribution 11 can be changed on substantially the same principle.

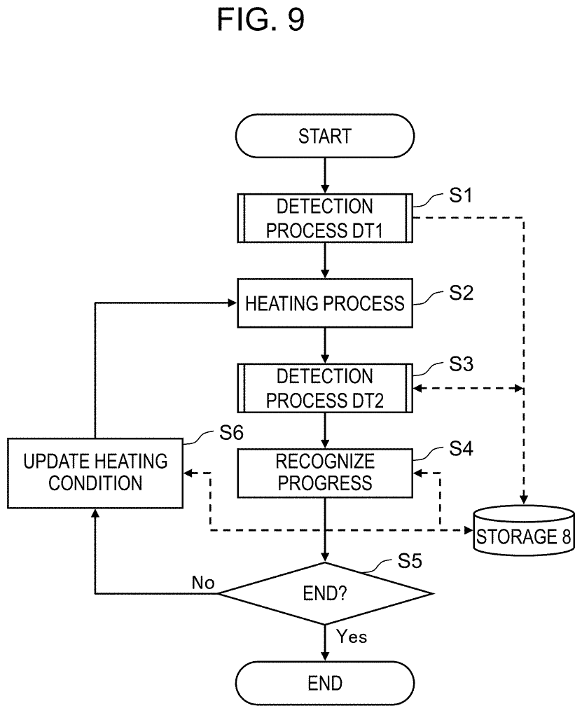

FIG. 9 is a flowchart showing the overall heating control according to the present exemplary embodiment. When a user provides an instruction to start cooking using an operation unit (not shown in the drawings), controller 7 first performs detection process DT1 (Step S1).

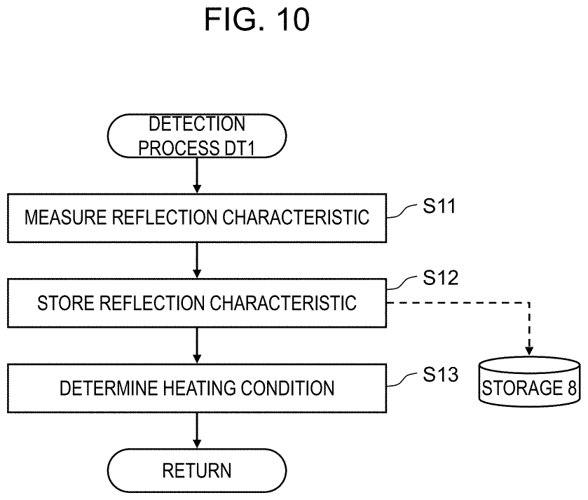

FIG. 10 is a flowchart showing details of detection process DT1 (Step S1). As shown in FIG. 10, controller 7 measures reflection characteristic 9 on the basis of the reflected microwave power detected for each frequency through the frequency sweep (Step S11).

Controller 7 causes storage 8 to store reflection characteristic 9 in association with the heating condition used (Step S12). Controller 7 determines the heating condition in view of reflection characteristic 9, the heating efficiency, and the like (Step S13) and ends detection process DT1.

Returning to FIG. 9, controller 7 heats the heating target in accordance with the determined heating condition (Step S2). After heating for a specific length of time, controller 7 performs detection process DT2 (Step S3).

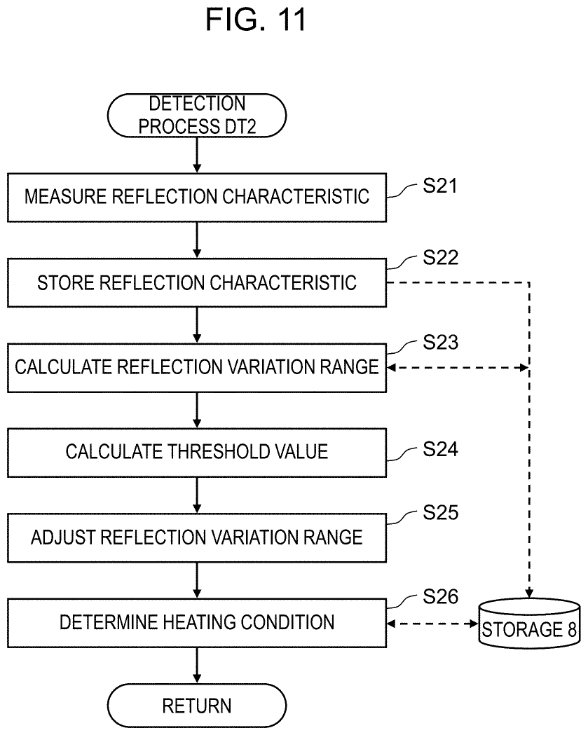

FIG. 11 is a flowchart showing details of detection process DT2. In detection process DT2, controller 7 measures reflection characteristic 9 on the basis of the reflected microwave power detected for each frequency through the frequency sweep (Step S21). Controller 7 causes storage 8 to store obtained reflection characteristic 9 in association with the heating condition used (Step S22).

Controller 7 calculates reflection variation range 12 on the basis of the difference between two reflection characteristics 9 measured in detection processes DT1 and DT2 (Step S23). After the start of cooling, the result of detection process DT1 and the result of detection process DT2 are used in the first calculation of reflection variation range 12. In the second and subsequent calculation of reflection variation range 12, the result of last detection process DT2 and the result of current detection process DT2 are used.

Controller 7 calculates a threshold value by multiplying the absolute value of reflection variation range 12 in a heating condition that is identical to the heating condition used in the heating process (Step S2 in FIG. 9) by a predetermined coefficient (Step S24). By setting a positive value less than 1 to the coefficient, controller 7 sets a numerical value less than each value of reflection variation range 12 measured in this heating condition to the threshold value.

Next, controller 7 replaces, by “0”, a value having a sign different from the sign of the value of reflection variation range 12 measured in the heating condition that is identical to the previous heating condition used in Step S2 in FIG. 9 among the values of reflection variation range 12 obtained in Step S23 (Step S25).

Using a heating condition in which the absolute value of each value of reflection variation range 12 adjusted is less than a threshold value, absorbed microwave power distribution 11 can be changed as described with reference to FIG. 4A, FIG. 4B, and FIG. 8. Therefore, controller 7 determines this heating condition as a heating condition to be used next. Each time controller 7 determines the heating condition to be used next, controller 7 causes storage 8 to store reflection characteristic 9 (Step S26) and ends detection process DT2.

Returning to FIG. 9, controller 7 recognizes the progress of cooking on the basis of the information obtained in detection process DT2 (Step S3) (Step S4). Controller 7 determines, on the basis of the progress of the cooking, whether or not the cooking is to be ended, and according to the result of the determination, causes the cooking to be ended or continued (Step S5).

When the cooking is to be continued (No in Step S5), controller 7 sets, to the heating condition to be actually used, the heating condition to be used next that has been determined in detection process DT2 (Step S3), updates the heating condition (Step S6), and transitions to the next heating process. When the cooking is to be ended (Yes in Step S5), controller 7 ends the cooking by stopping oscillator 3.

Thus, when the updated heating condition is used, absorbed microwave power distribution 11 different from absorbed microwave power distribution 11 obtained in the former heating condition can be generated. Therefore, by repeatedly updating the heating condition until a required amount of heat is given to heating target 2, it is possible to perform the heating process in which the heating is less uneven.

In the heating control shown in FIG. 9, the reflection variation range is calculated on the basis of the reflection characteristic obtained through the frequency sweep described with reference to FIG. 2A to FIG. 4B. Instead of the frequency sweep, the phase sweep described with reference to FIG. 7A to FIG. 8 may be used. In this case, the heating condition includes the frequency and the phase difference. According to the present aspect, the order of approximation of the absorbed microwave power distribution 11 can be found.

In the present exemplary embodiment, oscillator 3 may generate only the high-frequency power at a specific frequency without executing the frequency sweep and may be configured to output the high-frequency power at only a single frequency. In this case, the reflection variation range may be calculated on the basis of the reflection characteristic obtained through the phase sweep alone, and the order of approximation of the absorbed microwave power distribution 11 may be found by comparison with the threshold value.

As described above, according to the present exemplary embodiment, various heating targets can be optimally heated.

By causing storage 8 to store all the heating conditions used, controller 7 can avoid repeated use of a heating condition in which the same or similar absorbed microwave power distribution 11 is generated.

Reflection characteristic 9 and reflection variation range 12 change in a continuous manner and do not change in a discontinuous manner. Therefore, controller 7 may cause storage 8 to store only reflection characteristics 9 indicating local maximum and minimum of the change, in other words, an extremum of the change, for example. Even in this case, controller 7 can reproduce original data by properly interpolating the stored data.

As mentioned above, by selecting a frequency to be used as the heating condition from the frequency band in which the value of reflection variation range 12 is close to zero, it is possible to change the absorbed microwave power distribution without increasing the reflected microwave power. This means that a frequency band in which reflection variation range 12 is great is avoided in determining the heating condition to be used next.

With this principle, the heating condition to be used next may be determined by a method different from that described above. For example, controller 7 may calculate the maximum value of reflection variation range 12 for each frequency and cause storage 8 to store the maximum value. Each time controller 7 calculates reflection variation range 12, controller 7 may refer to the maximum value thereof and determine, as the heating condition to be used next, a frequency band in which reflection variation range 12 is small.

As another method, controller 7 may calculate an accumulated value of reflection variation range 12 for each frequency obtained and cause storage 8 to store the accumulated value. Each time controller 7 calculates reflection variation range 12, controller 7 may refer to the accumulated value and determine, as the heating condition to be used next, a frequency band in which reflection variation range 12 is small.

After determining the heating condition to be used next, controller 7 may use another heating condition before using said heating condition.

### INDUSTRIAL APPLICABILITY

As described above, the high-frequency heating device according to the present disclosure can also be applied to drying devices, heating devices for ceramic art, garbage disposers, semiconductor manufacturing devices, chemical reaction devices, and the like, in addition to cooking appliances that use dielectric heating.

### REFERENCE MARKS IN THE DRAWINGS

1 heating chamber

2 heating target

2a defrosted meat

2b frozen meat

3 oscillator

4a, 4b amplifier

5a, 5b feeder

6a, 6b detector

7 controller

8 storage

9 reflection characteristic

9A, 9B reflection characteristic curve

10 phase adjuster

11 absorbed microwave power distribution

12 reflection variation range

13 similar heating condition

What is claimed is:

1. A high-frequency treatment device comprising:
a heating chamber configured to accommodate a heating target;
an oscillator operatable to generate high-frequency power having one of frequencies in a predetermined frequency band;
at least one feeder operable to supply incident microwave power based on the high-frequency power to the heating chamber;
a detector operable to detect the incident microwave power and reflected microwave power returning from the heating chamber to the at least one feeder; and
a controller, wherein
the controller is operable to cause the oscillator to execute a frequency sweep and is operable to measure a reflection characteristic based on the incident microwave power and the reflected microwave power for each heating condition including a frequency, and
the controller is operable to determine, based on a reflection variation range indicating a change in the reflection characteristic for each heating condition, a heating condition to be used next.

2. The high-frequency treatment device according to claim 1, further comprising:
a phase adjuster, wherein
the at least one feeder includes a first feeder and a second feeder,
the phase adjuster is connected to the oscillator and is operable to adjust a phase difference between the high-frequency power to be supplied by the first feeder and the high-frequency power to be supplied by the second feeder, and
the controller is operable to cause the phase adjuster to execute a phase sweep and is operable to measure the reflection characteristic based on the incident microwave power and the reflected microwave power for each heating condition that further includes the phase difference.

3. The high-frequency treatment device according to claim 1, wherein
the controller is operable to determine, as the heating condition to be used next, the heating condition in which an absolute value of the reflection variation range is less than a threshold value.

4. The high-frequency treatment device according to claim 3, wherein
the threshold value is obtained by multiplying the absolute value of the reflection variation range by a predetermined coefficient.

5. The high-frequency treatment device according to claim 1, further comprising:
a storage, wherein
the controller is operable to cause the storage to store the reflection characteristic each time the heating condition to be used next is determined.

6. The high-frequency treatment device according to claim 5, wherein
the controller is operable to, each time the reflection variation range is calculated, calculate a maximum of the reflection variation range, cause the storage to store the maximum, and determine, based on the maximum, the heating condition to be used next.

7. The high-frequency treatment device according to claim 5, wherein
the controller is operable to, each time the reflection variation range is calculated, calculate an accumulated value of the reflection variation range, cause the storage to store the accumulated value, and determine, based on the accumulated value, the heating condition to be used next.

8. The high-frequency treatment device according to claim 5, wherein
the controller is operable to replace, by zero, a value having a sign different from a sign of a value of the reflection variation range measured in the heating condition that is identical to a previous heating condition among values of the reflection variation range for each heating condition.

9. The high-frequency treatment device according to claim 2, wherein
the frequency sweep is an operation to change the frequency at regular or irregular intervals over the predetermined frequency band, and the phase sweep is an operation to change the phase difference at regular or irregular intervals over a predetermined angular range.

10. The high-frequency treatment device according to claim 5, wherein
the controller is operable to cause the storage to store only the reflection characteristic that indicates an extremum of the change.
